(19) United States
(12) Patent Application Publication
(10) Pub. No.: US 2025/0242200 A1
(43) Pub. Date: Jul. 31, 2025

(54) LAUNCHPAD AUTOMATION SYSTEM

(71) Applicant: Driveline Baseball Enterprises LLC, Kent, WA (US)

(72) Inventor: Kyle John BODDY, Seattle, WA (US)

(73) Assignee: Driveline Baseball Enterprises LLC, Kent, WA (US)

(21) Appl. No.: 18/905,471

(22) Filed: Oct. 3, 2024

Related U.S. Application Data
(60) Provisional application No. 63/626,987, filed on Jan. 30, 2024.

(51) Int. Cl. A63B 24/00; G01S 13/58; G06N 3/092; G06T 7/277; G06T 7/80; G06V 20/40

(52) U.S. Cl. CPC A63B 24/0006; G01S 13/58; G06N 3/092; G06T 7/277; G06T 7/80; G06V 20/44

(57) ABSTRACT

A system and method for automating markerless motion capture by integrating radar tracking, embedded computing, machine vision, and machine learning techniques. A radar gun tracks object speed and triggers an embedded computer system. The embedded system decodes signals from the radar gun and triggers high-speed cameras to capture video footage. Machine learning algorithms optimize camera settings and triggering accuracy over time by analyzing captured biomechanical data.

### CROSS-REFERENCE

This application claims priority to U.S. Provisional Application No. 63/626,987, titled LAUNCHPAD AUTOMATION SYSTEM, filed Jan. 30, 2024, the contents of which are hereby incorporated by reference.

### TECHNICAL FIELD

The present disclosure relates generally to systems and methods for biomechanical analysis and feedback for human and object motion. More specifically, the present disclosure relates to systems and methods for automating motion capture technologies such as high-speed cameras by integrating radar guns and embedded systems.

### BACKGROUND

Motion tracking and biomechanical analysis technologies have applications across sports training, physical therapy, industrial workflows, and other domains involving analyzing and improving repetitive human or object motions. There is a need for techniques and systems that can accurately and reliably capture detailed motion data, process it to extract biomechanical parameters, and provide actionable and personalized feedback for correcting deficiencies and improving performance.

In the field of baseball pitching, the concept of the “kinetic chain” has been established, referring to the sequence of energy transfer through the body during the pitching motion. As explained by Kyle Boddy in the book Hacking the Kinetic Chain, proper timing and sequencing in the kinetic chain is crucial for injury prevention and performance optimization in pitching. However, deficiencies such as “opening up” too early are common and disrupt the kinetic chain. Quantitative analysis of video, sensor data, and metrics like timing of pelvis rotation can identify kinetic chain problems. Prescriptive training programs (e.g., using weighted implements, bands, and other tools) can help ingrain proper mechanics and strengthen the kinetic chain. Data-driven biomechanical analysis combined with sport-specific training can enhance both health and performance outcomes. The kinetic chain principles extend beyond baseball to other sports and athletic motions.

While current motion capture techniques require extensive manual effort, the disclosed invention aims to automate the process using an integrative hardware and software solution. Specifically, this invention combines precision radar tracking, embedded computing, and machine vision cameras to enable automated, markerless motion capture with minimal human intervention. The integration of these technologies provides an intelligent, adaptive system that can efficiently track object motion, detect salient events, and activate cameras to capture high-fidelity footage automatically. Implementation of such an automated system within a sports training facility would substantially improve operational efficiency by eliminating the need for manual camera operation and intensive post-processing. The following summary describes an exemplary embodiment of such an automated, integrative motion capture system.

### SUMMARY

The present disclosure outlines a novel system and method for automating markerless motion capture, specifically characterized by a method comprising: receiving a speed signal from a radar gun; decoding said signal within an embedded computer to identify a motion event based on predefined criteria; and triggering machine vision cameras to capture footage of said event, where the triggering mechanism is refined through the application of machine learning algorithms based on historical data.

Central to the Launchpad Automation System is the employment of advanced machine learning algorithms, including reinforcement learning, to dynamically adjust camera settings for optimal image capture. These algorithms are specifically designed to analyze the quality of captured footage in real-time, optimizing parameters such as shutter speed, frame rate, and resolution to significantly reduce motion blur and enhance image clarity.

A distinctive feature of the disclosed system is its innovative application of radar technology to achieve continuous, real-time tracking of an object's speed and trajectory. This is accomplished through a sophisticated embedded computing system, which decodes radar-generated data streams to precisely identify optimal instances for actuating connected machine vision cameras. This capability ensures the automated, accurate acquisition of high-resolution video data for detailed biomechanical analysis, eliminating the need for manual intervention in the data capture process.

Further advancing beyond mere automation, the system incorporates proprietary machine learning algorithms to elevate video capture quality to unprecedented levels. These algorithms, through a process of continuous learning and adjustment, meticulously modulate critical camera parameters—including shutter speed, frame rate, and resolution—to optimize image clarity, minimize motion blur, and achieve optimal exposure. Additionally, the system employs advanced reinforcement learning techniques to iteratively refine the precision of camera trigger timing and positioning based on accumulated data over successive sessions. This dynamic adaptation process, informed by real-time performance feedback, ensures ongoing enhancement of video quality and analytical accuracy, marking a significant leap forward in automated motion capture technology.

The automated, adaptive, and scalable nature of the Launchpad System provides a flexible and cost-efficient solution for motion capture. It eliminates the need for human camera operators and can be implemented for diverse sports, industrial, and scientific applications. The integration of radar, embedded computing, and machine intelligence results in robust and high-fidelity video footage that can readily lend itself to biomechanical data extraction. By leveraging this integrated hardware and software solution, the Launchpad System delivers automated, optimized motion capture capabilities.

### BRIEF DESCRIPTION OF THE DRAWINGS

FIG. 1 illustrates a block diagram of an embodiment of the Launchpad Automation System.

FIG. 2 illustrates a flowchart of an embodiment of the operation of the Launchpad Automation System.

FIG. 3 illustrates an embodiment of the Launchpad Automation System prototype.

FIG. 4 provides a close-up view of the Embedded Computer (3) in the Launchpad Automation System prototype.

FIG. 5 shows the human-readable debug log display from the Raspberry Pi Embedded Computer (3) in the Launchpad Automation System prototype.

FIG. 6 provides a rear view of one of the Edgertronic High Speed SC1 Machine Vision Cameras (4) used in the Launchpad Automation System prototype.

### DETAILED DESCRIPTION OF ILLUSTRATIVE EMBODIMENTS

### Overview

The Launchpad Automation System provides an automated and intelligent platform for high-fidelity, markerless motion capture. The system integrates specialized hardware components including radar for tracking, an embedded computer for control, and machine vision cameras for recording footage. Custom software centering around machine learning algorithms enables adapting and optimizing the system's automation capabilities over time.

The core capabilities and components of the Launchpad System are as follows: First, a radar gun precisely tracks the speed and trajectory of moving objects such as baseballs continuously in real-time. An embedded computer analyzes this radar data, detects salient motion events, and triggers attached high-speed cameras at exactly the right moments to capture the events. In addition, and concurrently, machine learning algorithms may be employed to tune the camera settings for optimal image quality and refine the timing/positioning of the triggers.

This integration of real-time motion tracking, event detection, automated camera activation, and, optionally, intelligent optimization provides a comprehensive platform for automated biomechanical data capture. By coordinating the hardware and software elements, high-fidelity footage can be obtained with limited human intervention. The system architecture and workflows provide adaptability to new scenarios and maintenance of optimal configurations through machine learning. The detailed description will expand on the components, functionality, workflows, and advantages of the Launchpad Automation System.

### System Architecture

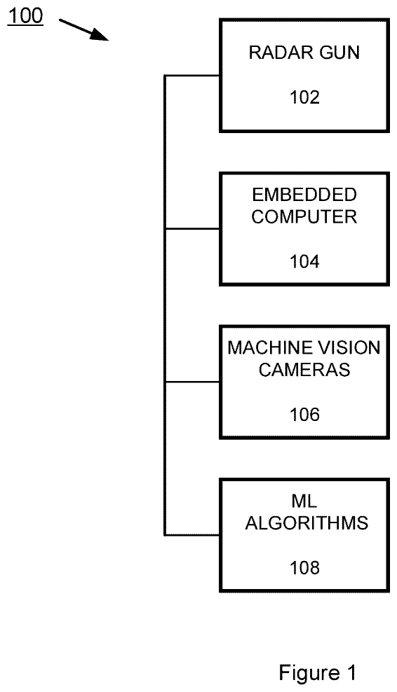

FIG. 1 illustrates a block diagram of an embodiment of the Launchpad Automation System 100. System 100 includes a Radar Gun 102, an Embedded Computer 104, and Machine Vision Cameras 106.

The Radar Gun 102 tracks the speed of a moving object, such as a baseball, and transmits speed data to the Embedded Computer 104. In one implementation, the Radar Gun 102 is a Stalker Radar Gun designed for sports tracking applications.

The Embedded Computer 104 is a small computer such as a Raspberry Pi capable of receiving data from the Radar Gun 102 and controlling external devices. The Embedded Computer 104 receives the speed data from the Radar Gun 102, decodes the data, and sends trigger signals to the Machine Vision Cameras 106 with precise timing based on the speed data.

The Machine Vision Cameras 106 are high-speed cameras capable of capturing video at 1000+ frames per second. The cameras 106 are electronically triggered by signals from the Embedded Computer 104 to capture video footage of the moving object at key moments in time. In one implementation, the cameras are Edgertronic high-speed cameras.

System 100 also implements Machine Learning Algorithms 108 to optimize the automation process. The algorithms 108 access the captured video footage and biomechanical data extracted from the footage. The algorithms 108 self-tune camera settings like shutter speed, frame rate, and resolution for optimal motion capture. The algorithms 108 also improve the accuracy of triggering over time by analyzing object trajectories across multiple sessions.

### Operation

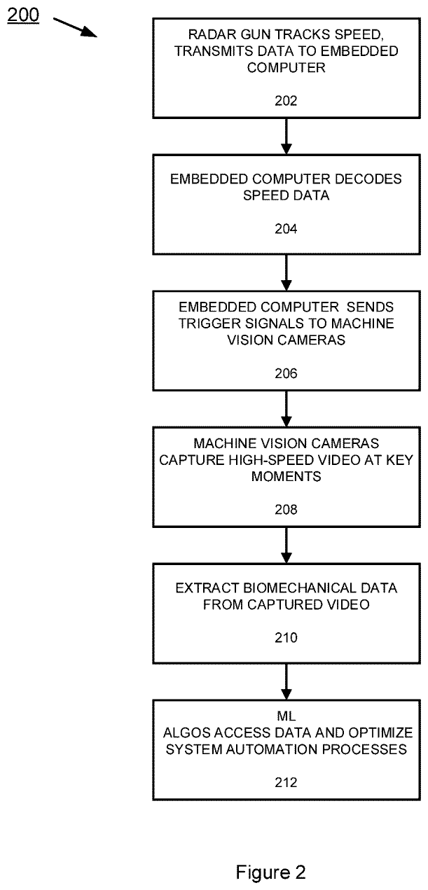

FIG. 2 illustrates a flowchart of an embodiment of the operation 200 of the Launchpad Automation System 100. First, the Radar Gun 102 tracks the speed of a moving object and transmits speed data to the Embedded Computer 104, as in 200.

Embedded Computer 104 receives the speed data from the Radar Gun 102, as in 202. Embedded Computer 104 then decodes the speed data, as in 204.

Based on the speed data, the Embedded Computer 104 sends trigger signals with precise timing to the Machine Vision Cameras 106, as in 206. The trigger signals cause the Machine Vision Cameras 106 to capture video footage of the moving object.

The Machine Vision Cameras 106 capture high-speed video, as in 208. The cameras 106 capture video at key moments based on the timing of the trigger signals from the Embedded Computer 104.

System 100 then extracts biomechanical data from the captured video footage, as in 210. This may involve processing the video to extract metrics related to the moving object's position, velocity, acceleration, and other kinematic and kinetic quantities.

Finally, Machine Learning Algorithms 108 access the captured data and optimize the system's automation processes, as in 212. This involves tuning camera settings and improving triggering accuracy over multiple sessions.

The Launchpad Automation System 100 provides an automated, adaptable, and scalable solution for motion capture applications. The integration of radar tracking, embedded computing, machine vision, and machine learning techniques enables robust and precise automation for biomechanical analysis.

### Prototype System

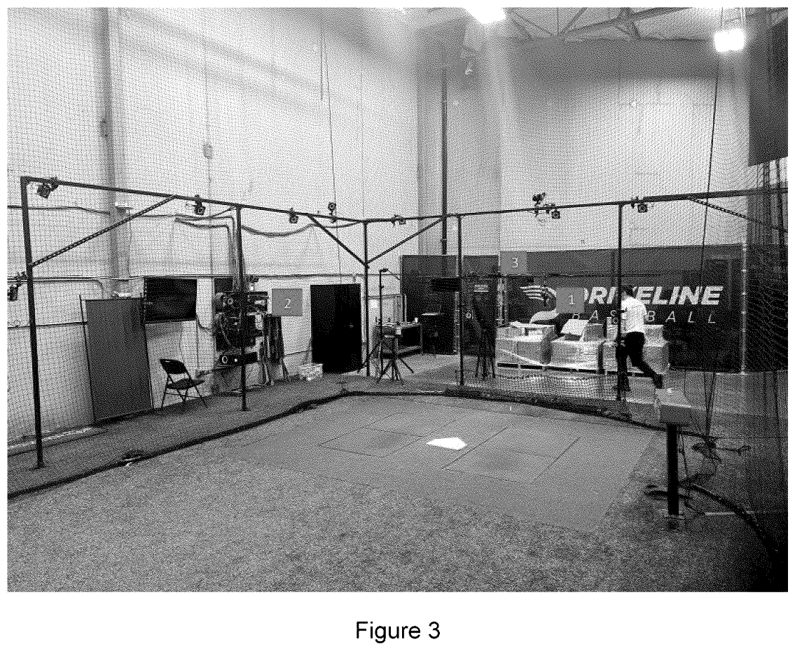

FIG. 3 illustrates an embodiment of the Launchpad Automation System prototype. A Stalker Radar Gun (1) is positioned behind home plate to track the speed of pitches. The Radar Gun (1) is connected via a USB to Serial converter cable to a Raspberry Pi Embedded Computer (3) serving as the command and control unit. Custom Python code runs on the Embedded Computer (3) to decode signals from the Radar Gun (1). The Embedded Computer (3) sends trigger signals via genlock or multicast to the Edgertronic High Speed Machine Vision Cameras (4) to control their precision triggering mechanisms. Also shown is a Switching Station and Server Hardware (2) for data storage and processing.

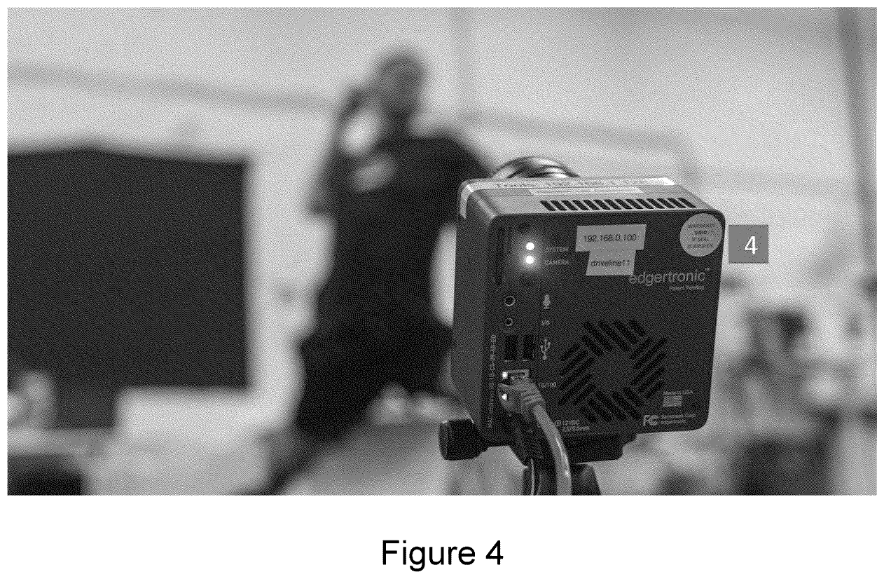

FIG. 4 provides a close-up view of the Embedded Computer (3) in the Launchpad Automation System prototype. The Raspberry Pi Embedded Computer (3) receives speed data from the Radar Gun (1—not shown) through the USB to Serial converter cable. The custom Python code running on the Embedded Computer (3) analyzes and decodes this speed data and determines when to send electronic trigger signals to the Machine Vision Cameras (4—not shown). The Embedded Computer (3) enables the automation of the camera triggering based on the object motion detected by the Radar Gun (1).

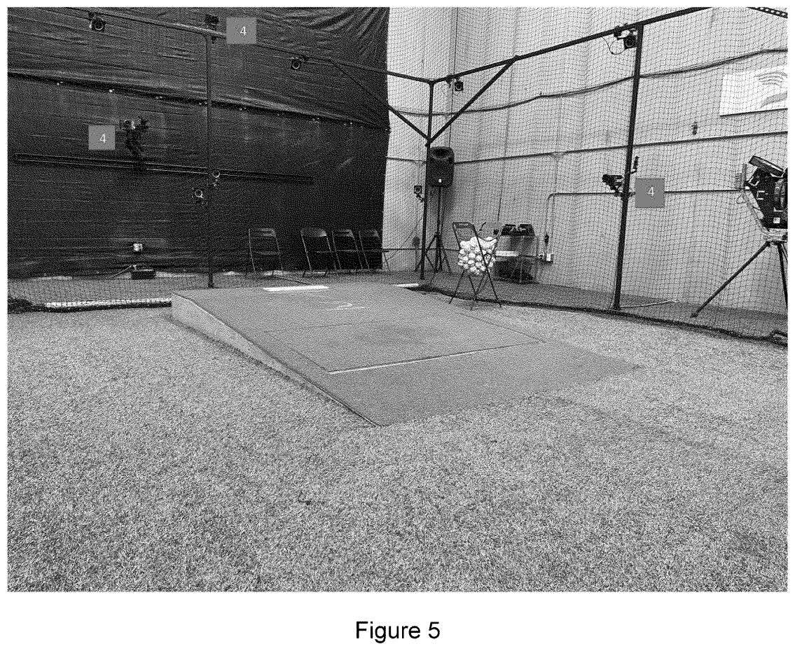

FIG. 5 shows the human-readable debug log display from the Raspberry Pi Embedded Computer (3) in the Launchpad Automation System prototype. The display allows operators to monitor the Embedded Computer's (3) decoding of Radar Gun (1) speed data and triggering of the Machine Vision Cameras (4). The log provides real-time visibility into the automation system's state and aids in validation, troubleshooting, and optimization.

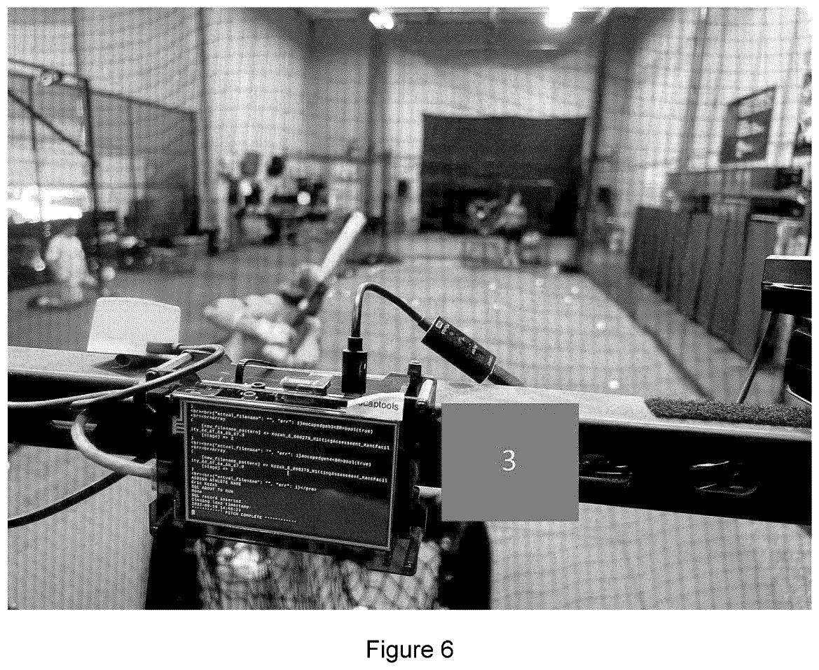

FIG. 6 provides a rear view of one of the Edgertronic High Speed SC1 Machine Vision Cameras (4) used in the Launchpad Automation System prototype. The electronic trigger mechanism on the back of Camera (4) allows it to respond to signals from the Embedded Computer (3—not shown) and rapidly start video recording. The automated triggering coordinated with the Radar Gun's (1—not shown) speed tracking enables capturing high fidelity footage of brief events such as pitches.

### Python Code

The Raspberry Pi Embedded Computer runs custom Python code that enables the core automation functions of decoding radar data and triggering the cameras. Initialization involves setting up serial communication with the radar gun over the USB cable using the pyserial library and configuring the necessary baud rate and parameters.

Once initialization is complete, the code enters an infinite loop where it continuously reads in and decodes the incoming serial data stream from the radar gun's speed output. The raw serial data is processed and converted into actual speed values in miles per hour. Noise in the readings is smoothed out using a Kalman filter implementation.

As data is decoded, the code actively checks if the current speed exceeds a defined threshold indicating an event of interest like a pitch is occurring. If the trigger condition is met based on the speed, the timing of the event is precisely calculated using the timestamps of the last few radar speed data points.

At the computed event timestamp, the code sends a multicast trigger packet to the cameras. This automated signal causes the cameras to rapidly initiate video recording to capture footage of the event. Additional functionality like pitch counting, max speed tracking, and data logging can also be incorporated.

The Python code loops indefinitely to provide real-time control and coordination between the radar gun input and camera triggering. It gives the automation system intelligence by continuously analyzing radar data, detecting events, activating cameras at precise times, and adapting to changes. The modular software architecture also provides flexibility for customization.

### Machine Learning

In one example embodiment, the machine learning algorithms utilize techniques like reinforcement learning to tune camera parameters like shutter speed, frame rate, resolution, and ISO (light sensitivity) for optimal motion capture.

For shutter speed, the algorithms try different shutter durations and evaluate the resulting image sharpness and motion blur. The shutter duration that provides the clearest images of the moving object with minimal blur is reinforced over time.

For frame rate, the algorithms try different fps settings and evaluate metrics like temporal resolution of the moving object's trajectory. The fps that provides sufficient resolution without excessive redundancy is reinforced.

For resolution, the algorithms try different megapixel and resolution presets and evaluate image clarity, noise levels, and data storage requirements. The optimal balance is reinforced over time.

For ISO, the algorithms adjust this parameter to balance exposure and noise. The ISO setting that provides a sufficiently bright image without excessive graininess is learned through iteration.

The algorithms may also utilize techniques like policy gradients and deep reinforcement learning to improve the triggering accuracy. They learn timing offsets to account for system latencies and optimize when to fire the trigger signals based on object speed and trajectory data. The timing that results in the most accurately captured footage is reinforced over multiple sessions.

By continuously optimizing these camera parameters through machine learning, the system can automatically tune itself to provide the best quality motion capture footage for a given scenario. The algorithms improve automation accuracy and adapt to changing conditions over time.

### Real-time Camera Optimization

The machine learning algorithms can adjust camera settings dynamically in real-time to optimize motion capture quality on a continuous basis. By monitoring metrics like image sharpness, motion blur, and exposure on individual frames or sections of footage, the algorithms can detect suboptimal camera configurations as the conditions change. Upon detecting issues like excessive blur or under/overexposure, the algorithms can immediately adjust parameters like shutter speed, frame rate, and ISO to counteract the problems.

Techniques like Q-learning (see below) enable the algorithms to learn optimal policies for making real-time camera adjustments based on feedback, such as increasing shutter speed if motion blur is observed. Regression methods allow predicting necessary tweaks to settings like frame rate by analyzing real-time tracking data of factors like object speed and trajectory path. Neural networks and deep reinforcement learning give the algorithms capacity to learn complex camera control strategies from raw real-time footage directly, going beyond just motion data.

Q-learning is a reinforcement learning technique that allows an agent (the algorithm in this case) to learn an optimal policy by interacting with its environment. The algorithm is learned by sequentially observing states, taking actions, and receiving rewards or penalties.

In this system, the algorithm observes the current state of the footage in real-time, such as the amount of motion blur. It then chooses an action, such as increasing the shutter speed. It receives a reward if the adjustment improves the footage quality, like reducing blur. Or it may receive a penalty if the adjustment is detrimental.

By repeatedly adjusting parameters, observing the effects, and receiving feedback, the algorithm learns a Q-value for each state-action pair. This Q-value represents the expected long-term reward for taking that action in that state. Over many iterations of trial-and-error, the algorithm learns the optimal policy—which action to take in each state to maximize the cumulative reward.

For example, the algorithm may learn that increasing shutter speed when motion blur is high leads to better image quality over time. It will then update the Q-value to favor that action in blurry states. As the Q-values converge, following the policy with the highest Q-values results in optimally adjusting camera settings.

The key advantage of Q-learning is that the algorithm directly interacts with the real-time environment and learns the optimal adjustments empirically. By leveraging immediate feedback, it can learn dynamically adjusting policies that would be difficult to derive analytically. This enables adapting the camera in real-time to produce optimal footage.

By implementing the adjustment logic and algorithms on the embedded computer, changes to settings like shutter speed can be made in just milliseconds or microseconds. This enables truly dynamic optimization on a continuous basis. Rather than just improving performance between sessions, the system can now remain maximally configured as the conditions change moment to moment. In this manner, real-time optimization keeps the motion capture quality as accurate as possible throughout use.

### Conclusion

The Launchpad Automation System outlined herein provides an integrative, adaptable platform for automating high-speed motion capture. The use of radar technology allows continuous, precision tracking of object speed and trajectory. An embedded computer handles decoding this radar data and triggering attached machine vision cameras at optimal moments in time to capture events.

Integrating specialized radar, embedded computing, and high-speed imaging components provides an automated solution to obtaining biomechanical data. However, the principles disclosed could be applied utilizing a variety of alternative technologies. For instance, other object tracking means such as laser, ultrasonic, or video-based solutions could replace the radar component. Event detection and camera triggering logic could be handled by various embedded controllers or computing architectures. And different high-speed or ultra-high-speed camera models could be incorporated.

A key advantage of the system is the use of machine learning techniques to actively enhance automation accuracy over time. But numerous adaptive algorithms and models could be employed based on end-use constraints. The system's modular, extensible design allows such alternative technologies to be interchanged while retaining automation capabilities. The core methods of precisely tracking motion, detecting salient events, and activating cameras in response can be generalized across many embodiments.

In summary, the Launchpad Automation System provides a flexible, cost-effective platform for automated, high-fidelity motion capture suited to diverse sports, industrial, and research applications. The exemplary embodiment serves to illustrate one methodology to integrate radar, computing, and machine vision components. But the disclosed techniques for precision motion tracking, automated triggering, and intelligent optimization can be adapted to create alternative automation systems using other suitable technologies. The core invention lies in the automated integration of motion tracking, event detection, and data capture—not just the specific means described herein.

Wherefor I/we claim:

1. A system for automated motion capture, comprising:
a radar gun configured to track speed of a moving object;
an embedded computer communicatively coupled to the radar gun and configured to:
receive speed data from the radar gun,
decode the speed data, and
generate trigger signals based on the decoded speed data;
one or more machine vision cameras communicatively coupled to the embedded computer and configured to capture high-speed video footage in response to the trigger signals; and
a machine learning module configured to optimize camera settings of the one or more machine vision cameras based on analysis of captured video footage.

2. The system of claim 1, wherein the camera settings optimized by the machine learning module include at least one of shutter speed, frame rate, resolution, and light sensitivity (ISO).

3. The system of claim 1, wherein the machine learning module employs reinforcement learning techniques to optimize the camera settings.

4. The system of claim 1, wherein the embedded computer is further configured to:
identify a motion event based on predefined criteria applied to the decoded speed data; and
generate the trigger signals in response to identifying the motion event.

5. The system of claim 1, wherein the radar gun is configured to continuously track the speed and trajectory of the moving object in real-time.

6. The system of claim 1, wherein the one or more machine vision cameras are configured to capture video at 1000+ frames per second.

7. The system of claim 1, further comprising a data storage unit configured to store the captured high-speed video footage and extracted biomechanical data.

8. The system of claim 1, wherein the machine learning module is further configured to
analyze object trajectories across multiple capture sessions, and
improve trigger signal timing accuracy based on the analysis.

9. The system of claim 1, wherein the embedded computer is further configured to apply a Kalman filter to smooth out noise in the speed data received from the radar gun.

10. The system of claim 1, wherein the machine learning module is configured to optimize the camera settings in real-time during a capture session.

11. The system of claim 1, wherein the embedded computer is configured to send trigger signals to the one or more machine vision cameras via at least one of a genlock connection and a multicast packet.

12. A method for automated motion capture, comprising:
receiving speed data from a radar gun tracking a moving object;
decoding the speed data using an embedded computer;
generating trigger signals based on the decoded speed data;
activating one or more machine vision cameras to capture high-speed video footage in response to the trigger signals;
analyzing the captured video footage; and
optimizing camera settings of the one or more machine vision cameras based on the analysis using machine learning algorithms.

13. The method of claim 12, wherein optimizing the camera settings comprises adjusting at least one of shutter speed, frame rate, resolution, and light sensitivity (ISO).

14. The method of claim 12, wherein the machine learning algorithms employ reinforcement learning techniques to optimize the camera settings.

15. The method of claim 12, further comprising:
identifying a motion event based on predefined criteria applied to the decoded speed data; and
generating the trigger signals in response to identifying the motion event.

16. The method of claim 12, wherein receiving speed data comprises continuously receiving speed and trajectory data of the moving object in real-time.

17. The method of claim 12, wherein capturing high-speed video footage comprises capturing video at 1000+ frames per second.

18. The method of claim 12, further comprising:
logging debug information related to the decoding of speed data and triggering of cameras; and
displaying the debug information on a human-readable display.

19. The method of claim 12, further comprising:
calculating a precise event timestamp based on the decoded speed data; and
sending the trigger signals to the one or more machine vision cameras at the calculated event timestamp.

20. A system for automated motion capture, comprising:
means for tracking speed of a moving object;
means for decoding speed data received from the means for tracking;
means for generating trigger signals based on the decoded speed data; and
means for capturing high-speed video footage in response to the trigger signals.

21. The system of claim 20, further comprising:
means for analyzing the captured video footage; and
means for optimizing camera settings based on the analysis using machine learning algorithms.

22. The system of claim 21, wherein the means for optimizing camera settings employs reinforcement learning techniques to adjust at least one of shutter speed, frame rate, resolution, and ISO.
